(19) United States
(12) Patent Application Publication
(10) Pub. No.: US 2026/0108891 A1
(43) Pub. Date: Apr. 23, 2026

(54) INTEGRATED MAGNETIC SEPARATION APPARATUS

(71) Applicants: BEIJING SAVANT BIOTECHNOLOGY CO., LTD., Beijing (CN); TIANJIN SAVANT BIOTECHNOLOGY CO., LTD., Tianjin (CN)

(72) Inventors: Xian HUANG, Tianjin (CN); Zhen YANG, Tianjin (CN); Chenguang HU, Tianjin (CN); Kang DU, Tianjin (CN); Xinquan LIU, Tianjin (CN); Si LIN, Tianjin (CN)

(21) Appl. No.: 19/160,694

(22) PCT Filed: Aug. 11, 2023
(86) PCT No.: PCT/CN2023/112474

§ 371 Date: Aug. 28, 2025

(30) Foreign Application Priority Data
May 26, 2023 (CN) 202310601210.5

(51) Int. Cl. B03C 1/033

(52) U.S. Cl. CPC B03C 1/0335; B03C 2201/26

(57) ABSTRACT

The present disclosure relates to an integrated magnetic separation apparatus. The integrated magnetic separation apparatus includes: a micro-pipe, which is a horizontally arranged linear hollow pipe, and includes a first liquid inlet, a second liquid inlet, a first liquid outlet and a second liquid outlet, the first liquid inlet and the first liquid outlet being respectively arranged at two ends of the micro-pipe; a coil array, which includes several annular magnetic coils arranged in parallel, the micro-pipe penetrating internal cavities of the annular magnetic coils, and the annular magnetic coils being arranged at intervals on the outer side of the micro-pipe; and a drive circuit board, which is electrically connected to the coil array, and is used for controlling an electric current of the coil array. In the present disclosure, by means of controlling the annular magnetic coils, after being powered on, the small annular magnetic coils can generate a uniform electric field or a gradient electric field without needing to be subjected to mechanical displacement or rotation, and then magnetic beads are controlled to move in the micro-pipe, thereby realizing reactions and washing.

### CROSS REFERENCE TO RELATED APPLICATION

This application claims priority to Chinese Patent Application No. titled “INTEGRATED MAGNETIC SEPARATION APPARATUS” and filed to the State Patent Intellectual Property Office on, the entire contents of which are incorporated herein by reference.

### TECHNICAL FIELD

The present disclosure relates to the field of magnetic separation technology, and more particularly, to an integrated magnetic separation apparatus.

### BACKGROUND

Superparamagnetic nanoparticles and particles have broad potential applications in medical diagnosis, serving as efficient tools for manipulating various analytes such as proteins, Ribonucleic Acid (RNA), Deoxyribonucleic Acid (DNA), viruses, bacteria, and cells. They have unique characteristic of permanent magnetic moment, which allows them to be remotely controlled using an external magnetic field. In the field of biomedical analysis, reaction and cleaning of the analytes are crucial steps.

At present, the existing magnetic separation technology is completed by manual labor in several hours. The process is as follows. First, a reaction solution and a sample solution (the sample solution is a solution containing magnetic microspheres) are mixed to ensure that the magnetic microspheres are in full contact with the reaction solution. Next, a magnetic separator is used for sorting, and then the same method is used for washing. Alternatively, the reaction or washing cycle may be repeated as needed until the desired purity is achieved. This method is laborious and requires the use of a plurality of devices such as vibrating screens and magnetic separators, further increasing time and labor required for the separation process. On this basis, some studies choose to use robotic arms instead of manual operation, but the space occupied by the robotic arms is too large, and separate operating equipment needs to be provided for the use of the robotic arms. Moreover, repair and maintenance costs of the robotic arms are too high, which undoubtedly increases usage costs.

Recently, some studies have explored the use of permanent magnets in micro-pipe equipment to achieve separation of particles and collection of reaction products by manually or automatically controlling translation or rotation of the permanent magnets. Because the permanent magnets require translation or rotation, the equipment requires a complex mechanical structure to achieve the translation or rotation of the permanent magnets, which makes it difficult to miniaturize the permanent magnet micro-pipe equipment for portable analysis.

### SUMMARY

A main objective of the present disclosure is to provide an integrated magnetic separation apparatus, and a technical problem to be solved is to provide an integrated magnetic separation apparatus. By means of controlling the annular magnetic coils, after being powered on, the small annular magnetic coils can generate a uniform electric field or a gradient electric field without needing to be subjected to mechanical displacement or rotation, and then magnetic beads are controlled to move in a micro-pipe, thereby realizing reactions and washing. In the present disclosure, strength of the electric field generated by the annular magnetic coils can be controlled by adjusting parameters of the annular magnetic coils, such as number of turns and thickness. In this way, smaller device size and adjustable performance can be achieved, thereby promoting complex operation of magnetic particles.

The objective of the present disclosure and the solved technical problem are achieved through the following technical solutions. An integrated magnetic separation apparatus proposed according to the present disclosure includes:
a micro-pipe serving as a horizontally arranged linear hollow pipe, the micro-pipe including a first liquid inlet, a second liquid inlet, a first liquid outlet and a second liquid outlet, the first liquid inlet and the first liquid outlet being respectively arranged at two ends of the micro-pipe, and both the second liquid inlet and the second liquid outlet being arranged on a wall of the micro-pipe;
a coil array including several annular magnetic coils arranged in parallel, the micro-pipe penetrating internal cavities of the annular magnetic coils, and the annular magnetic coils being arranged at intervals on an outer side of the micro-pipe, outer diameters of the annular magnetic coils being 8 to 15 mm, and thicknesses thereof being 2 to 5 mm, and a spacing distance between any two adjacent annular magnetic coils being 2 to 4 mm; and
a drive circuit board electrically connected to the coil array, the drive circuit board being configured to control an electric current of the coil array.

Preferably, in the aforementioned integrated magnetic separation apparatus, the several annular magnetic coils are arranged on a same center axis, and the micro-pipe extends through the annular magnetic coils along the center axis.

Preferably, in the aforementioned integrated magnetic separation apparatus, an inner diameter of the micro-pipe is 1 to 2 mm, and the annular magnetic coil has an inner diameter of 2.4 to 4.5 mm, an outer diameter of 9 to 12 mm, a thickness of 2 to 4 mm, and number of turns of 300 to 350.

Preferably, in the aforementioned integrated magnetic separation apparatus, the second liquid inlet and the second liquid outlet are respectively arranged on two sides of the wall of the micro-pipe, and the first liquid outlet and/or the second liquid outlet are separately provided with a detachable plug.

Preferably, in the aforementioned integrated magnetic separation apparatus, a hydrophobic coating is provided on an inner wall of the micro-pipe, and a thickness of the hydrophobic coating is 1 to 2 μm.

Preferably, in the aforementioned integrated magnetic separation apparatus, the drive circuit includes:
a boost converter electrically connected to several annular magnetic coil drivers, the annular magnetic coil drivers being connected in parallel to each other;
a processor electrically connected to the several annular magnetic coil drivers by means of several annular magnetic coil controllers, the annular magnetic coil controllers being corresponding to the annular magnetic coil drivers one to one and being connected in series;
a data line interface connected to a client side; and
a power strip arranged at an end of a surface of the drive circuit board.

Preferably, in the aforementioned integrated magnetic separation apparatus, the processor is an MCU (Micro Control Unit) processor; the boost converter adjusts a voltage to 10 to 13 V; each of the annular magnetic coil drivers is connected in parallel to a Schottky diode; and the annular magnetic coil controllers are NMOS field-effect transistors.

Preferably, the aforementioned integrated magnetic separation apparatus further comprises:
a fixed circuit board, pin headers being provided on two sides of a surface of the fixed circuit board, and the pin headers being inserted into the power strip such that the fixed circuit board is electrically connected to the drive circuit board, and the surface of the fixed circuit board being provided with several electrically conductive holes; and
a coil connector comprising a base, a side of the base being connected to the annular magnetic coils, other side of the base being provided with several single-pin sockets, metal pins of the annular magnetic coils being connected to pin bodies of the single-pin sockets, the single-pin sockets being inserted into the electrically conductive holes to power on the annular magnetic coils.

Preferably, the aforementioned integrated magnetic separation apparatus further comprises:
a lower locator comprising a plurality of first grooves arranged in parallel, the annular magnetic coils being inserted into the first grooves to fix positions of the annular magnetic coils, two ends of the lower locator further comprising second grooves, two ends of the micro-pipe being fixedly connected to the second grooves, the lower locator being a hollow structure, and the two ends of the lower locator being separately provided with a condensing medium inlet and a condensing medium outlet; and
an upper locator comprising a plurality of third grooves arranged in parallel, the third grooves being corresponding to the first grooves one to one and being configured to fix the positions of the annular magnetic coils, two ends of the upper locator further comprising fourth grooves clamped to the two ends of the micro-pipe to fix a position of the micro-pipe.

Preferably, the aforementioned integrated magnetic separation apparatus further comprises a magnetic bead including a magnetic microsphere and a magnetic particle, where the magnetic bead is capable of moving in the micro-pipe under an action of the several annular magnetic coils. The magnetic microsphere is magnetic metal coated with an organic layer on its surface, and the magnetic particle is uncoated magnetic metal. A particle size of the magnetic microsphere is 10 to 50 μm, a particle size of the magnetic particle is smaller than 5 μm, and a mass ratio of the magnetic microsphere to the magnetic particle is 1:0.2 to 1.2.

Through the above technical solutions, the integrated magnetic separation apparatus proposed by the present disclosure at least has following advantages.

The integrated magnetic separation apparatus described in the present disclosure comprises: a micro-pipe, a coil array, a magnetic bead, and a drive circuit board. The coil array comprises several annular magnetic coils. To miniaturize the apparatus, small annular magnetic coils are used, each of which has an outer diameter of 8 to 15 mm and a thickness of 2 to 5 mm. However, the small annular magnetic coils cannot drive magnetic microspheres with smaller particle sizes. Lower magnetic metal content in the magnetic microspheres with smaller particle sizes results in lower magnetic responsiveness. Therefore, other drive modes may be adopted in the existing technologies. However, the present disclosure is different from the existing technologies in that magnetic beads are improved in the present disclosure. In the present disclosure, based on a fact that the magnetic bead only includes the magnetic microsphere, the magnetic particle is additionally provided. Under the action of the annular magnetic coils, the magnetic microsphere and the magnetic particle may attract each other to form a whole, which can improve the magnetic responsiveness of the magnetic microsphere, such that the magnetic bead can be driven by the small annular magnetic coils.

After the magnetic particle is additionally provided, it is also required to consider tightness of binding between the magnetic microsphere and the magnetic particle, so a particle size of the magnetic microsphere and a particle size of the magnetic particle should be controlled. When a particle size difference between the magnetic microsphere and the magnetic particle is too large, this may cause the magnetic microsphere to detach from the magnetic particle, resulting in sample loss. Therefore, the present disclosure chooses to use a magnetic microsphere with a particle size of 10 to 50 μm and a magnetic particle with a particle size smaller than 5 μm, to prevent the magnetic microsphere from detaching from the magnetic particle. Meanwhile, the magnetic beads obtained by mixing the magnetic microspheres and the magnetic particles in a mass ratio of 1:0.2 to 1.2 serve as a main body of a magnetic separation system, thereby enabling small annular magnetic coils to drive the small-particle-size magnetic beads to move in a micro-pipe.

Compared to a magnetic field generated by a permanent magnet used in the prior art, a magnetic field generated by the annular magnetic coils used in the present disclosure is weaker, and thus its range of action is smaller. Therefore, to ensure that the magnetic beads of the present disclosure are continuously subjected to a magnetic field force in the micro-pipe and are not out of control, spacing between adjacent annular magnetic coils is set to 2 to 4 mm.

The integrated magnetic separation apparatus described in the present disclosure supports an automatic mode. In the automatic mode, users can set number of coil cycles and pulse operating time for each coil, enabling an operating sequence of each coil to be executed in a certain order according to a preset operating program of the apparatus. This can achieve reliable and effective separation of the magnetic particles from solutions, and achieve effective mixing of reactants with macromolecular or micromolecular target objects such as DNA, antigens, antibodies, receptors, ligands, and enzymes, and can support internal washing of the micro-pipes and collection of waste liquids.

The above description is merely an overview of the technical solutions of the present disclosure. To more clearly understand technical means of the present disclosure and implement them in accordance with contents of the specification, preferred embodiments of the present disclosure are described in detail below with reference to the drawings.

### BRIEF DESCRIPTION OF THE DRAWINGS

FIG. 1 is a schematic diagram of an integrated magnetic separation apparatus according to an embodiment of the present disclosure;

FIG. 2 is a schematic structural diagram of a micro-pipe and a schematic diagram of a reaction process according to an embodiment of the present disclosure;

FIG. 3 is a schematic diagram of an overall structure of the integrated magnetic separation apparatus according to an embodiment of the present disclosure;

FIG. 4 is a schematic diagram of a drive circuit of the integrated magnetic separation apparatus according to an embodiment of the present disclosure;

FIG. 5 is a schematic diagram of magnetic beads under the action of a magnetic field according to the present disclosure;

FIG. 6 is a schematic diagram of a radial cross section of a coil connector of an annular magnetic coil according to an embodiment of the present disclosure;

FIG. 7 is a schematic diagram of pulse timing of the annular magnetic coil according to an embodiment of the present disclosure; and

FIG. 8 is a schematic diagram of a spacing distance between the annular magnetic coils of the present disclosure.

### DETAILED DESCRIPTION

To further elaborate on the technical means and effects adopted by the present disclosure to achieve the predetermined invention objectives, the specific implementations, structures, features, and effects of the integrated magnetic separation apparatus proposed in accordance to the present disclosure are described in detail below in conjunction with the accompanying drawings and preferred embodiments. In the following descriptions, different “one embodiment” or “embodiments” do not necessarily refer to the same embodiment. In addition, specific features, structures, or characteristics in one or more embodiments may be combined in any suitable form.

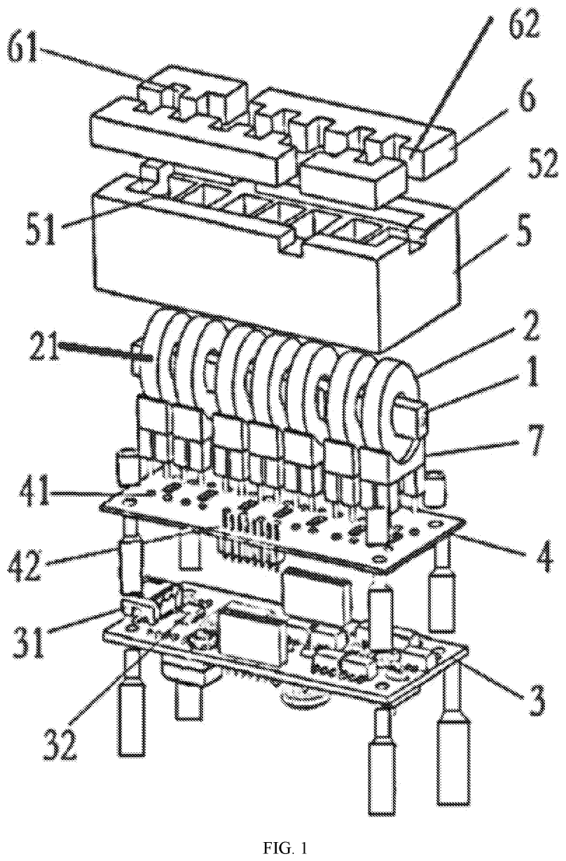

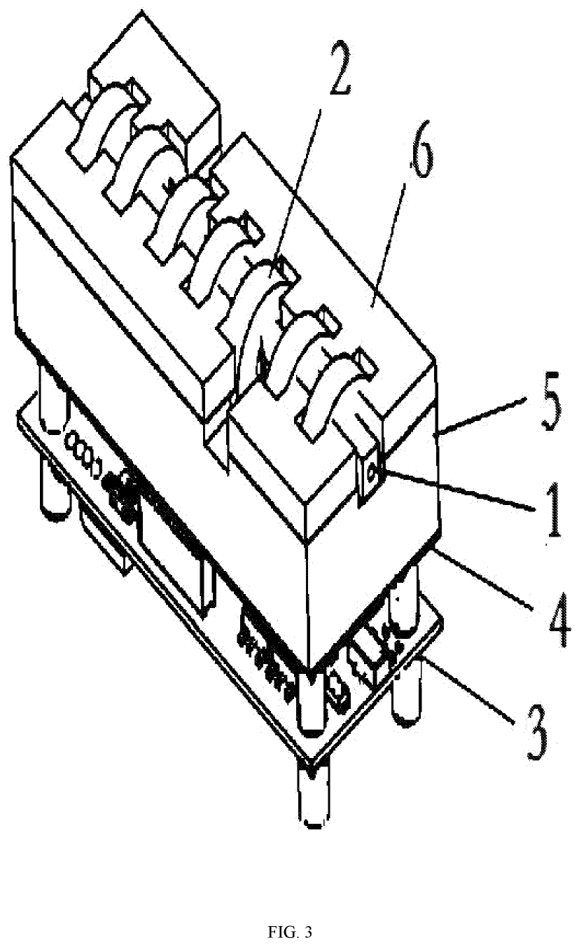

The present disclosure proposes an integrated magnetic separation apparatus, as shown in FIGS. 1 to 8, the integrated magnetic separation apparatus includes:
a micro-pipe 1 serving as a horizontally arranged linear hollow pipe, the micro-pipe 1 including a first liquid inlet 101, a second liquid inlet 106, a first liquid outlet 102 and a second liquid outlet 107, where the first liquid inlet 101 and the first liquid outlet 102 are respectively arranged at two ends of the micro-pipe 1, and both the second liquid inlet 106 and the second liquid outlet 107 are arranged on a wall of the micro-pipe 1;
a coil array 2 including several annular magnetic coils 21 arranged in parallel, where the micro-pipe 1 penetrates internal cavities of the annular magnetic coils 21, and the annular magnetic coils 21 are arranged at intervals on an outer side of the micro-pipe 1, outer diameters of the annular magnetic coils 21 are 8 to 15 mm, and thicknesses thereof are 2 to 5 mm, and a spacing distance between any two adjacent annular magnetic coils 21 are 2 to 4 mm; and
a drive circuit board 3 electrically connected to the coil array, the drive circuit board 3 being configured to control an electric current of the coil array.

The micro-pipe 1 is a horizontally arranged linear hollow pipe, which may be divided into a liquid inlet cavity 103, a reaction washing cavity 104, and a liquid outlet cavity 105 based on an operating state of magnetic beads. After a sample (containing a solvent and the magnetic beads) is injected from the first liquid inlet 101 into the liquid inlet cavity using a pipette, under the action of the annular magnetic coils 21, the magnetic beads can sequentially pass through the liquid inlet cavity 103, the reaction washing cavity 104, and the liquid outlet cavity 105, finally flow out of the first liquid outlet 102, and are collected.

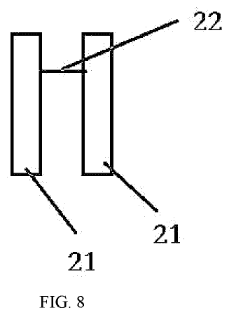

The coil array 2 is comprised of a plurality of annular magnetic coils 21 arranged in parallel at certain intervals. Spacing between any two adjacent annular magnetic coils 21 is 2 to 4 mm. As shown in FIG. 8, the spacing is a spacing distance 22 between surfaces of the two adjacent annular magnetic coils 21 facing each other. Outer diameters of the annular magnetic coils 21 in the coil array are controlled between 8 mm and 15 mm, and thicknesses of the annular magnetic coils 21 are controlled at between 2 mm and 5 mm. The outer diameters, thicknesses, and the spacing distances of the annular magnetic coils are controlled, and then based on setting of a PC client side the annular magnetic coils operate in accordance with a timing pulse to control movement of the magnetic beads, such that reaction and cleaning operations of the magnetic beads inside the micro-pipe 1 are controlled by means of the annular magnetic coil 21s. Inner diameters of the annular magnetic coils 21 only need to meet the requirement that the micro-pipe 1 can smoothly pass through the annular magnetic coils 21. The spacing distance between centers of two adjacent annular magnetic coils is 2 to 4 mm, which can keep the magnetic beads staying in the magnetic field generated by the annular magnetic coils at all times, such that the magnetic beads are continuously subjected to a magnetic field force and are not out of control. The setting of this distance is related to the outer diameters, the thicknesses and the number of turns of the annular magnetic coils, wire diameters of metal wires, and sizes and compositions of the magnetic beads, and may be changed according to changes of the annular magnetic coils and the magnetic beads.

Preferably, in the aforementioned integrated magnetic separation apparatus, the several annular magnetic coils 21 are arranged on a same center axis, and the micro-pipe 1 extends through the annular magnetic coils 21 along the center axis.

The annular magnetic coils 21 of the present disclosure are arranged on the same center axis, and the micro-pipe 1 extends through the annular magnetic coils 21 along the center axis. This arrangement can make magnetic field distribution of the annular magnetic coils 21 more uniform, thereby making it easier for the magnetic beads 200 inside the micro-pipe 1 to be controlled by the annular magnetic coils 21.

Preferably, in the aforementioned integrated magnetic separation apparatus, an inner diameter of the micro-pipe 1 is 1 to 2 mm, and each of the annular magnetic coils 21 has an inner diameter of 2.4 to 4.5 mm, an outer diameter of 9 to 12 mm, a thickness of 2 to 4 mm, and number of turns of 300 to 350.

In the present disclosure, the inner diameter of the micro-pipe is 1 to 2 mm, and the inner diameter of each of the annular magnetic coils is 2.4 to 4.5 mm. A wall of the micro-pipe of the present disclosure is provided with a second liquid inlet and a second liquid outlet. The second liquid inlet and the second liquid outlet of the present disclosure may be connected to an external pipeline to allow a reaction liquid to be introduced and discharged. To make it easier to remove the micro-pipe from the annular magnetic coils, the inner diameter of each of the annular magnetic coils is slightly larger than a width and a height of the micro-pipe, making it easier to remove the micro-pipe from the annular magnetic coils and making replacement and disassembly of the micro-pipe more convenient and efficient. Preferably, each of the annular magnetic coils of the present disclosure has an outer diameter of 9 to 12 mm, a thickness of 2 to 4 mm, and number of turns of 300 to 350. When the spacing between two adjacent annular magnetic coils is 2 to 4 mm, the magnetic field generated by the annular magnetic coils can be more uniform, and movement speed of the magnetic beads can reach 5 cm/s, which is much higher than the movement speed of the magnetic beads in the prior art. As a result, the magnetic beads can fully contact the reaction solution, resulting in a more complete reaction and improving accuracy of experimental data.

In addition, increasing the number of turns and the thickness of each of the annular magnetic coils, the wire diameters of the metal wires and electric current passing through the annular magnetic coils can also improve magnetic responsiveness of the magnetic beads with smaller particle sizes. However, increasing the number of turns and the thickness of each of the annular magnetic coils and the wire diameters of the metal wires may undoubtedly increase sizes of the annular magnetic coils, resulting in an increase in the volume of the device, and it is impossible to observe motion states of the magnetic beads in the micro-pipe. Increasing the electric current can enhance the magnetic field strength, which enables the magnetic beads with lower particle sizes to move. However, the increase in the electric current may increase heat generated by the annular magnetic coils, which may cause target objects loaded on surfaces of the magnetic beads to become inactive or denatured, leading to experimental failure. In the present disclosure, a plurality of small magnetic coils arranged at intervals are used in combination with the addition of specific amounts and sizes of magnetic particles, to achieve the purpose of controlling small-particle-size magnetic microspheres by small magnetic coils.

Preferably, in the aforementioned integrated magnetic separation apparatus, the second liquid inlet 106 and the second liquid outlet 107 are respectively arranged on two sides of the wall of the micro-pipe 11, and the first liquid outlet 102 and/or the second liquid outlet 107 are separately provided with a detachable plug.

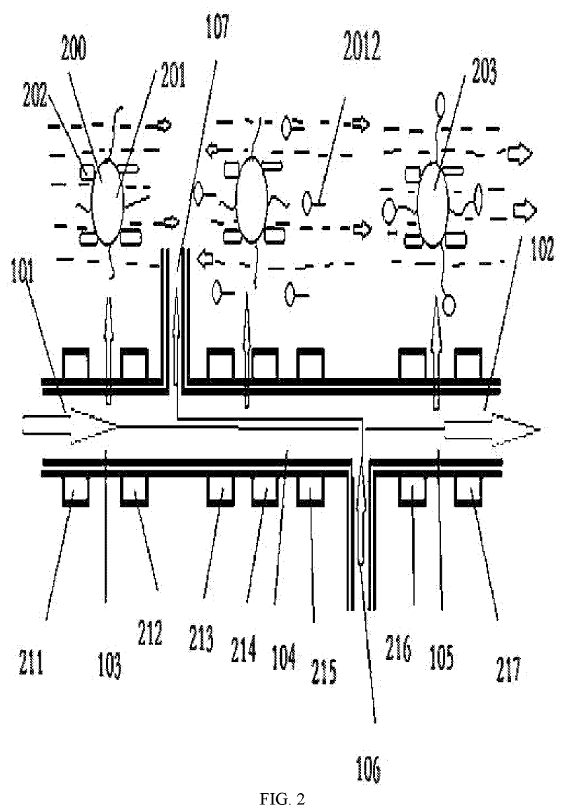

The second liquid inlet 106 and the second liquid outlet 107 described in the present disclosure may be arranged on the same side or on two sides of the micro-pipe 1. The configuration in FIG. 2 is the optimal choice, that is, the second liquid inlet 106 and the second liquid outlet 107 are distributed on the two sides of the micro-pipe 1. The second liquid inlet 106 gets close to the first liquid outlet 102, the second liquid outlet 107 gets close to the first liquid inlet 101, and the second liquid outlet 107 keeps away from the first liquid outlet 102, such that impurities in the reaction solution can be prevented from flowing out when the magnetic beads are collected. Furthermore, This configuration enables the reaction solution, when introduced through the second liquid inlet, to flow in a direction opposite to an injection direction of the sample, creating a counterflow effect. This facilitates sufficient contact between the reaction solution and the magnetic beads, thereby resulting in a more complete reaction and improving the accuracy of the experimental data. In addition, the arrangement of the second liquid inlet and the second liquid outlet, in combination with the design of the spacing, the outer diameter and the inner diameter of each of the annular magnetic coil, may achieve high-throughput flow of the reaction solution, which can reach 1.6 mL/min, while conventional devices only has a few tens of microliters per minute. Thus, use efficiency of the device can be improved.

Before use, the apparatus of the present disclosure needs to fill the micro-pipe 1 with a solvent, which is water generally, and then the first liquid outlet 102 is plugged up using the detachable plug. Next, the sample is injected using a pipette. After the sample is injected, the pipette is not removed, and is used as a plug for the first liquid inlet 101. This can prevent the reaction solution from being discharged through the first liquid inlet 101 and the first liquid outlet 102.

Preferably, in the aforementioned integrated magnetic separation apparatus, a hydrophobic coating is provided on an inner wall of the micro-pipe 1, and a thickness of the hydrophobic coating is 1 to 2 μm.

A material of the micro-pipe in the present disclosure is acrylonitrile-butadiene-styrene, which has certain adsorption properties and thus may cause sample loss. Therefore, in the present disclosure, a hydrophobic coating with a thickness of 1 to 2 μm is provided on the inner wall of the micro-pipe. The hydrophobic coating is a dense poly-p-xylylene membrane, which can reduce the sample loss. The present disclosure uses vapor deposition to deposit the hydrophobic coating on the inner wall of the micro-pipe. The use of the vapor deposition can make composition of the hydrophobic coating uniform, reduce adsorption effect of the micro-pipe on the magnetic beads, and thus can avoid the sample loss.

Preferably, in the aforementioned integrated magnetic separation apparatus, the drive circuit includes:
a boost converter 36 electrically connected to several annular magnetic coil drivers, the annular magnetic coil drivers being connected in parallel to each other;
a processor 32 electrically connected to the several annular magnetic coil drivers by means of several annular magnetic coil controllers, the annular magnetic coil controllers being corresponding to the annular magnetic coil drivers one to one and being connected in series;
a data line interface 31 connected to a client side 10; and
a power strip arranged at an end of a surface of the drive circuit board 3.

The boost converter adjusts an external voltage to an operating voltage of the annular magnetic coils. The external voltage is generally about 5V. A higher external voltage may lead to a larger volume of an external power supply, making it difficult to place. The processor 32 is provided with a plurality of ports, each of which is connected to a set of annular magnetic coil controllers and annular magnetic coil drivers, where the number of the sets connected is equal to the number of the annular magnetic coils. The data line interface is a USB (Universal Serial Bus) interface.

Preferably, in the aforementioned integrated magnetic separation apparatus, the processor 32 is an MCU (Micro Control Unit) processor; the boost converter adjusts a voltage to 10 to 13 V; each of the annular magnetic coil drivers is connected in parallel to a Schottky diode; and the annular magnetic coil controllers are NMOS field-effect transistors.

The drive circuit uses an adjustable booster to provide high voltage power to the coil array. The use of the NMOS field-effect transistors can control on/off of a power supply for the annular magnetic coil, where NMOS is short for N-Metal-Oxide Semiconductor. The Schottky diode connected in parallel at two ends of the annular magnetic coil driver prevents induced potential generated during on/off of the coil from damaging the driver or other components.

Preferably, the aforementioned integrated magnetic separation apparatus further comprises:
a fixed circuit board 4, pin headers being provided on two sides of a surface of the fixed circuit board 4, and the pin headers being inserted into the power strip such that the fixed circuit board 4 is electrically connected to the drive circuit board 3, and the surface of the fixed circuit board 4 being provided with several electrically conductive holes 41; and
a coil connector 7 comprising a base 72, a side of the base 72 being connected to the annular magnetic coils 21, other side of the base 72 being provided with several single-pin sockets 71, metal pins of the annular magnetic coils 21 being connected to pin bodies 73 of the single-pin sockets 71, the single-pin sockets 71 being inserted into the electrically conductive holes 41 to power on the annular magnetic coils 21.

The fixed circuit board is connected to the power strip of the drive circuit board 3 by means of pin headers to achieve electrical connection. Several electrically conductive holes 41 are arranged on the fixed circuit board, and a spacing of 2.5 to 3.5 mm is provided between any two adjacent electrically conductive holes 41. When the single-pin sockets 71 are inserted into the electrically conductive holes 41, the electric current flows through the electrically conductive holes 41 and the pin bodies 73 in sequence, flows to the metal pins of the annular magnetic coils 21 connected to the pin bodies 73, and finally flows to the annular magnetic coils 21 to ensure normal operation. Second, through holes are provided on four corners of the fixed circuit board and the drive circuit board 3, and the fixed circuit board and the drive circuit board 3 are fixed together by screws.

Preferably, the aforementioned integrated magnetic separation apparatus further comprises:
a lower locator 5 comprising a plurality of first grooves 51 arranged in parallel, the annular magnetic coils 21 being inserted into the first grooves 51 to fix positions of the annular magnetic coils 21, two ends of the lower locator 5 further comprising second grooves 52, two ends of the micro-pipe 1 being fixedly connected to the second grooves 52;
an upper locator 6 comprising a plurality of third grooves 61 arranged in parallel, the third grooves 61 being corresponding to the first grooves 51 one to one and being configured to fix the positions of the annular magnetic coils 21, two ends of the upper locator 6 further comprising fourth grooves 62 clamped to the two ends of the micro-pipe 1 to fix a position of the micro-pipe 1.

The first grooves 51 can fix the positions of the annular magnetic coils 21, ensuing the spacing between any two adjacent annular magnetic coils 21 to be fixed, to prevent touch by mistake or other situations from changing the spacing distance between the annular magnetic coils, thereby avoiding having an adverse effect on control of the magnetic beads. The second grooves 52 are arranged at two ends of the lower locator, and can support the micro-pipe, such that the micro-pipe is horizontally placed, and passes through the annular magnetic coils.

The third grooves 61 fit with the first grooves 51 to fix the positions of the annular magnetic coils, such that the spacing distance between the annular magnetic coils does not change. The fourth grooves 62 fix two sides of the micro-pipe 1 from two sides, to prevent lateral displacement of the micro-pipe 1.

Preferably, in the integrated magnetic separation apparatus mentioned above, the lower locator 5 is a hollow structure, and two ends of the lower locator 5 are provided with a condensing medium inlet and a condensing medium outlet.

The annular magnetic coils may generate heat during use, but too much heat may cause denaturation or inactivation of proteins in the samples, thus leading to experimental failure. Therefore, in the present disclosure, the lower locator 5 is designed into a hollow structure, into which a condensing medium may be introduced for cooling. The condensing medium may be condensed water, a condensing solvent, or gas, etc.

Preferably, the aforementioned integrated magnetic separation apparatus further comprises a magnetic bead 200 including a magnetic microsphere 201 and a magnetic particle 202, where the magnetic bead 200 is capable of moving in the micro-pipe 1 under an action of the several annular magnetic coils 21. The magnetic microsphere 201 is magnetic metal coated with an organic layer on its surface, and the magnetic particle 202 is uncoated magnetic metal. A particle size of the magnetic microsphere 201 is 10 to 50 μm, a particle size of the magnetic particle 202 is smaller than 5 μm, and a mass ratio of the magnetic microsphere 201 to the magnetic particle 202 is 1:0.2 to 1.2.

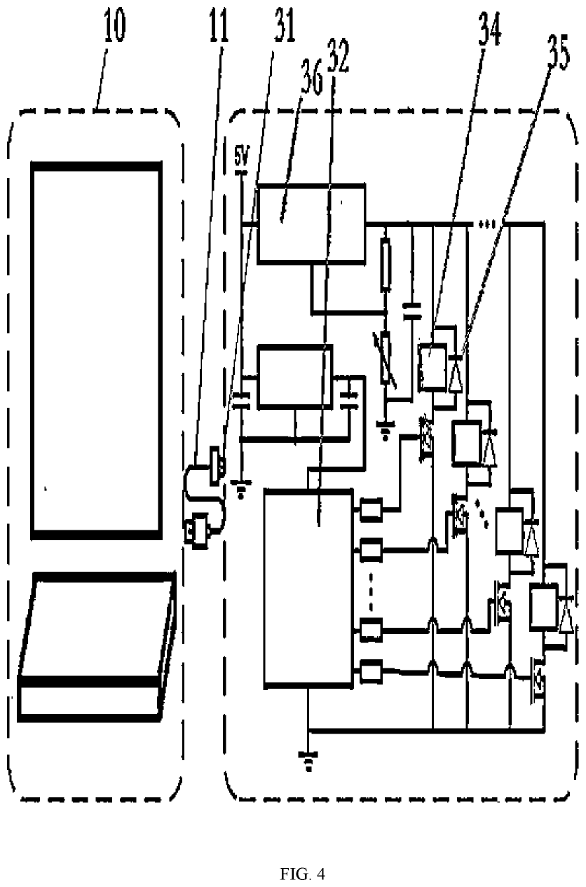

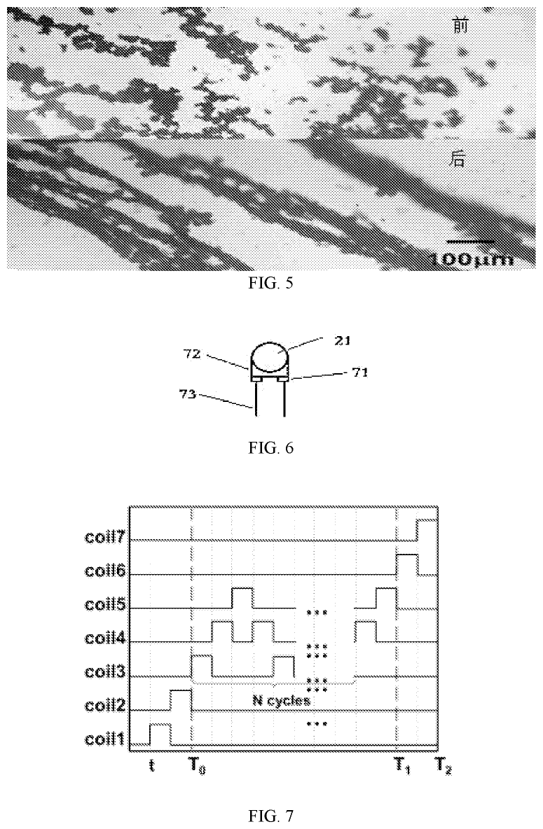

The implementation of using the miniaturized annular magnetic coil 21 to control the movement of the magnetic bead is not only related to the outer diameter, the thickness, and the spacing distance of the annular magnetic coil 21, but also is related to the magnetic bead. The magnetic bead 200 of the present disclosure comprises the magnetic microsphere 201 and the magnetic particle 202. The magnetic microsphere 201 is magnetic metal coated with an organic layer on its surface, and the organic layer is functionalized to load macromolecular or micromolecular target objects such as DNA, antigens, antibodies, receptors, ligands, and enzymes onto the surface of the magnetic microsphere 201. The magnetic particle 202 described in the present disclosure is uncoated irregularly-shaped magnetic metal. As shown in FIG. 5, before the action of the annular magnetic coils, the magnetic particles and the magnetic microspheres are in a dispersed state; and after the action of the annular magnetic coils, the magnetic particles and the magnetic microspheres can attract each other. Because the magnetic metal is irregular in shape, a plurality of magnetic metals can tightly adhere to the magnetic microspheres, thereby improving the magnetic responsiveness of the magnetic beads.

Because the particle size of the magnetic particle 202 is smaller than that of the magnetic microsphere 201, in an electric field of the same strength, movement speed of the magnetic particle 202 is greater than that of magnetic microsphere 202. Therefore, to ensure sufficient attraction force between the magnetic microsphere 201 and the magnetic particle 202, and to prevent the magnetic microsphere 201 from being broken away from the magnetic particle 202 due to the faster movement speed of the magnetic particle 202, and thus unable to control the magnetic bead 200, it is required to ensure that the particle size of the magnetic microsphere 201 is great than or equal to that of the magnetic particle 202. However, when the particle size of the magnetic microsphere 201 is approximately equal to that of the magnetic particle 202, some of the magnetic microspheres 201 may still be broken away, causing the magnetic microsphere 201 to be out of control and discharged from the second liquid outlet 107, resulting in the sample loss. Therefore, in the present disclosure, the particle size of the magnetic microsphere 201 is 10 to 50 μm, and the particle size of the magnetic particle 202 is smaller than 5 μm. In addition, ratio of addition amount of the magnetic microsphere 201 to addition amount of the magnetic particle 202 may lead to decrease in a load area of the magnetic microsphere 201, resulting in the sample loss. Therefore, in the present disclosure, mass ratio of the magnetic microsphere 201 to the magnetic particle 202 is controlled to be 1:0.2 to 1.2.

Taking FIG. 2 as an example, the magnetic bead 200 is loaded with DNA sample, which is injected into the first liquid inlet 101 using the pipette. Next, the DNA sample enters the liquid inlet cavity 103 under the action of annular magnetic coils 211 and 212, and then enters the reaction washing cavity 104 under the action of annular magnetic coils 213, 214, and 215. When the magnetic beads enter the reaction washing cavity 104, they move back and forth in the reaction washing cavity 104 under the action of the annular magnetic coils 213, 214, and 215, fully mixing and reacting with a fluorescent marker 2012 in the reaction solution, thereby obtaining fluorescently-labeled DNA magnetic bead products.

The magnetic metal described in the present disclosure may be Co, Ni, Fe, or Ni—Fe and Co—Fe alloys, etc., or ferrate or iron nitride, etc. Taking FIG. 2 as an example, based on the DNA sample loaded on the magnetic bead 200, the material and size (such as length, width, height, and inner diameter) of the micro-pipe, the size (such as inner diameter, outer diameter, and thickness) of the annular magnetic coils, the wire diameter and material of the metal wire, and the distribution of the annular magnetic coils, ferroferric oxide is selected as the material of the magnetic metal. In the present disclosure, the material of the magnetic metal may also be selected based on the type of the target sample loaded on the magnetic bead, the material and size (such as length, width, height, and inner diameter) of the micro-pipe, the size (such as inner diameter, outer diameter, and thickness) of the annular magnetic coils, the wire diameter and material of the metal wire, and the distribution of the annular magnetic coils. The present disclosure will be further explained below in conjunction with specific embodiments, but it should not be understood as limiting the scope of protection of the present disclosure. Some non-essential improvements and adjustments made to the present disclosure by those skilled in the art based on the content of the present disclosure still fall within the scope of protection of the present disclosure.

Unless otherwise specified, the materials, reagents and so on mentioned below are commercially available products that are well known to those skilled in the art. Unless otherwise specified, the methods described are well-known methods in this field. Unless otherwise defined, all technical or scientific terms used herein have the same meaning as commonly understood by those of ordinary skill in the art.

### Embodiments

An integrated magnetic separation apparatus comprises:

The present disclosure proposes an integrated magnetic separation apparatus, as shown in FIGS. 1 to 8, the integrated magnetic separation apparatus includes: a micro-pipe 1, a coil array 2, a magnetic bead 200, a drive circuit board 3, a fixed circuit board 4, a coil connector 7, a lower locator 5, and an upper locator 6.

The micro-pipe 1 is a horizontally arranged linear hollow pipe, and the micro-pipe 1 includes a first liquid inlet 101, a second liquid inlet 106, a first liquid outlet 102, and a second liquid outlet 107. The first liquid inlet 101 and the first liquid outlet 102 are arranged at two ends of the micro-pipe 1, respectively. The second liquid inlet 106 and the second liquid outlet 107 are arranged on two sides of a wall of the micro-pipe 1, respectively. The micro-pipe 1 has a length of 49 mm, a length of 2.5 mm and a width of 2.5 mm, and an inner diameter of 1 mm. The inner wall of the micro-pipe 1 is coated with a poly-p-xylylene hydrophobic coating having a thickness of 1 μm.

The coil array 2 includes seven annular magnetic coils 21 arranged in parallel, where the seven annular magnetic coils 21 are arranged on the same center axis. The micro-pipe 1 extends through the annular magnetic coils 21 along the center axis. The spacing distance between any two adjacent annular magnetic coils 21 is 3 mm. Each of the annular magnetic coils has an inner diameter of 4 mm, an outer diameter of 10 mm, a thickness of 3 mm, and number of turns of 300.

The magnetic bead 200 includes a magnetic microsphere 201 and a magnetic particle 202. The magnetic microsphere 201 is magnetic metal coated with an organic layer on its surface, and the magnetic particle 202 is uncoated magnetic metal. The particle size of the magnetic microsphere 201 is 20 μm, the particle size of the magnetic particle 202 is 1 μm, and the mass ratio of the magnetic microsphere 201 to the magnetic particle 202 is 1:1.

The drive circuit board 3 is electrically connected to the coil array, and the drive circuit board 3 is configured to control an electric current of the coil array. The drive circuit board 3 includes a boost converter, a processor, a data line interface, and a power strip.

The boost converter is electrically connected to seven annular magnetic coil drivers, and the seven annular magnetic coil drivers are connected in parallel to each other. The boost converter adjusts the voltage from 5 V to 12 V.

The processor 32 is an MCU (Micro Control UNIT) processor, which is electrically connected to the seven annular magnetic coil drivers by means of seven NMOS field-effect transistors. The NMOS field-effect transistors correspond to the annular magnetic coil drivers one to one, and are connected in series to the annular magnetic coil drivers. The NMOS is short for N-Metal-Oxide Semiconductor. Each of the annular magnetic coil drivers is connected in parallel to a Schottky diode.

The data line interface is a USB (Universal Serial Bus) interface, and is connected to the client side 10.

The power strip is arranged at an end of a surface of the drive circuit board 3.

Pin headers are provided at one end of a surface of the fixed circuit board 4, and the pin headers are inserted into the power strip such that the fixed circuit board 4 is electrically connected to the drive circuit board 3. The surface of the fixed circuit board 4 is provided with two rows of electrically conductive holes, with 14 electrically conductive holes in each row and 28 electrically conductive holes in total. Through holes are provided on four corners of the fixed circuit board 4 and the drive circuit board 3, and the fixed 4 circuit board and the drive circuit board 3 are fixed together by M2 screws.

The coil connector 7 comprises a base 72, where a side of the base 72 is connected to the annular magnetic coils 21 by means of an ultra-violet curable adhesive, and other side of the base 72 is provided with four single-pin sockets 71. Metal pins of the annular magnetic coils 21 are connected to pin bodies 73 of the single-pin sockets 71, and the single-pin sockets 71 are inserted into the electrically conductive holes 41 to power on the annular magnetic coils 21.

The lower locator 5 comprises seven first grooves 51 arranged in parallel. The annular magnetic coils 21 are inserted into the first grooves 51 to fix positions of the annular magnetic coils 21. Two ends of the lower locator 5 further comprise second grooves 52, and two ends of the micro-pipe 1 are fixedly connected to the second grooves 52.

The upper locator 6 comprises seven third grooves 61 arranged in parallel, where the third grooves 61 are corresponding to the first grooves 51 one to one and are configured to fix the positions of the annular magnetic coils 21. Two ends of the upper locator 6 further comprise fourth grooves 62 clamped to the two ends of the micro-pipe 1 to fix a position of the micro-pipe 1.

A usage method is described as follows, as shown in FIG. 2.

In Step S1, sample are injected from the first liquid inlet 101 of the micro-pipe 1 using the pipette, where the samples include: water, carboxylated magnetic microspheres loaded with DNA samples, and magnetic particles.

In Step S2, the magnetic coils 211 and 212 arranged outside the liquid inlet cavity 103 are actuated, and the samples are introduced into the liquid inlet cavity 103.

In Step S3, the magnetic coils 213, 214, and 215 arranged outside the reaction washing cavity 104 are actuated, and the samples are introduced into the reaction washing cavity 104.

In Step S4, the reaction solution is injected into the micro-pipe 1 through the second liquid inlet 106 using an injection pump, then the annular magnetic coils 213, 214, and 215 operate in accordance with a timing pulse to start a reaction, and a waste liquid discharged from the second liquid outlet 107 is collected using a waste liquid collector.

In Step S5, after the reaction is completed, introducing the reaction solution is stopped, and washing solution is injected into the micro-pipe 1 through the second liquid inlet 106 by using the injection pump. Next, the annular magnetic coils 213, 214, and 215 operate in accordance with a timing pulse to start washing, and a waste liquid discharged from the second liquid outlet 107 is collected using the waste liquid collector.

In Step S6, a finished product 203 is collected at the first liquid outlet 102 by using a product collector.

The above Steps may be performed in an automatic or manual mode in a PC client-side program, which is specifically described as follows.

In the automatic mode, in accordance with the above Steps S1 to S6, the magnetic coils are controlled according to a predetermined time sequence, as shown in FIG. 7. Abscissas in FIG. 7 represent time t, and ordinates represent pulses of a plurality of magnetic coils. The steps are described as follows.

During a sample injection time period T₀, the magnetic coil 1 (the magnetic coil 211) and the magnetic coil 2 (the magnetic coil 212) operate in accordance with a timing pulse. During a reaction or washing time period T₁, the magnetic coil (the magnetic coil 213), the magnetic coil (the magnetic coil 214), and the magnetic coil 5 (the magnetic coil 215) operate in accordance with a timing pulse.

During a product collection period T₂, the magnetic coil 6 (the magnetic coil 216) and the magnetic coil 7 (the magnetic coil 217) operate in accordance with a timing pulse.

In the manual mode, users can also independently control On or Off state of each magnetic coil, supporting a manual operation to achieve the Steps S1 to S6. Alternatively, after the reaction, the Step S5 is performed separately to wash the magnetic beads inside the micro-pipe.

Among the foregoing embodiments, description of various embodiments may be focused on differentially, and a part not expatiated in a certain embodiment may refer to related description of other embodiments.

The above descriptions are merely preferred embodiments of the present disclosure, and are not intended to limit the present disclosure in any form. Although the present disclosure has been disclosed by the above preferred embodiments, the embodiments are not intended to limit the present disclosure. Those skilled in the art may make some changes or modifications into equivalent embodiments with equal changes by utilizing the above disclosed technical contents without departing from the scope of the technical solution of the present disclosure. Therefore, the contents not departing from the technical solution of the present disclosure, any simple amendments, equivalent changes or modifications made to the above embodiments based on the technical essence of the present disclosure shall all fall within the scope of the technical solution of the present disclosure.

What is claimed is:

1. An integrated magnetic separation apparatus for biomedical analysis, comprising:
a micro-pipe serving as a horizontally arranged linear hollow pipe, the micro-pipe including a first liquid inlet, a second liquid inlet, a first liquid outlet and a second liquid outlet, the first liquid inlet and the first liquid outlet being respectively arranged at two ends of the micro-pipe, and both the second liquid inlet and the second liquid outlet being arranged on a wall of the micro-pipe;
a coil array including several annular magnetic coils arranged in parallel, the micro-pipe penetrating internal cavities of the annular magnetic coils, and the annular magnetic coils being arranged at intervals on an outer side of the micro-pipe, outer diameters of the annular magnetic coils being 8 to 15 mm, and thicknesses thereof being 2 to 5 mm, and a spacing distance between two adjacent annular magnetic coils being 2 to 4 mm;
a magnetic bead including a magnetic microsphere and a magnetic particle, the magnetic bead being capable of moving in the micro-pipe under an action of the several annular magnetic coils, the magnetic bead being injected from the first liquid inlet, and discharged from the first liquid outlet after reacting with a reaction solution, the magnetic microsphere being magnetic metal coated with an organic layer on its surface, the magnetic particle being uncoated magnetic metal, a particle size of the magnetic microsphere being 10 to 50 μm, a particle size of the magnetic particle being smaller than 5 μm, and a mass ratio of the magnetic microsphere to the magnetic particle being 1:0.2 to 1.2; and
a drive circuit board electrically connected to the coil array, the drive circuit board being configured to control an electric current of the coil array.

2. The integrated magnetic separation apparatus for biomedical analysis according to claim 1, wherein the several annular magnetic coils are arranged on a same center axis, and the micro-pipe extends through the annular magnetic coils along the center axis.

3. The integrated magnetic separation apparatus for biomedical analysis according to claim 1, wherein an inner diameter of the micro-pipe is 1 to 2 mm, and the annular magnetic coil has an inner diameter of 2.4 to 4.5 mm, an outer diameter of 9 to 12 mm, a thickness of 2 to 4 mm, and number of turns of 300 to 350.

4. The integrated magnetic separation apparatus for biomedical analysis according to claim 1, wherein the second liquid inlet and the second liquid outlet are respectively arranged on two sides of the wall of the micro-pipe, and the first liquid outlet and/or the second liquid outlet are separately provided with a detachable plug.

5. The integrated magnetic separation apparatus according to claim 1, wherein a hydrophobic coating is provided on an inner wall of the micro-pipe, a thickness of the hydrophobic coating being 1 to 2 μm.

6. The integrated magnetic separation apparatus for biomedical analysis according to claim 1, wherein the drive circuit comprises:
a boost converter electrically connected to several annular magnetic coil drivers, the annular magnetic coil drivers being connected in parallel to each other;
a processor electrically connected to the several annular magnetic coil drivers by means of several annular magnetic coil controllers, the annular magnetic coil controllers being corresponding to the annular magnetic coil drivers one to one and being connected in series;
a data line interface connected to a client side; and
a power strip, the power strip being arranged at an end of a surface of the drive circuit board.

7. The integrated magnetic separation apparatus for biomedical analysis according to claim 6, wherein the processor is an MCU (Micro Control Unit) processor, the boost converter adjusts a voltage to 10 to 13 V, each of the annular magnetic coil drivers is connected in parallel to a Schottky diode, and the annular magnetic coil controllers are NMOS field-effect transistors.

8. The integrated magnetic separation apparatus for biomedical analysis according to claim 6 further comprising:
a fixed circuit board, pin headers being provided on two sides of a surface of the fixed circuit board, and the pin headers being inserted into the power strip such that the fixed circuit board is electrically connected to the drive circuit board, and the surface of the fixed circuit board being provided with several electrically conductive holes; and
a coil connector comprising a base, a side of the base being connected to the annular magnetic coils, other side of the base being provided with several single-pin sockets, metal pins of the annular magnetic coils being connected to pin bodies of the single-pin sockets, the single-pin sockets being inserted into the electrically conductive holes to power on the annular magnetic coils.

9. The integrated magnetic separation apparatus for biomedical analysis according to claim 1 further comprising:
a lower locator comprising a plurality of first grooves arranged in parallel, the annular magnetic coils being inserted into the first grooves to fix positions of the annular magnetic coils, two ends of the lower locator further comprising second grooves, two ends of the micro-pipe being fixedly connected to the second grooves, the lower locator being a hollow structure, and the two ends of the lower locator being separately provided with a condensing medium inlet and a condensing medium outlet; and
an upper locator comprising a plurality of third grooves arranged in parallel, the third grooves being corresponding to the first grooves one to one and being configured to fix the positions of the annular magnetic coils, two ends of the upper locator further comprising fourth grooves clamped to the two ends of the micro-pipe to fix a position of the micro-pipe.
